(19) United States
(12) Patent Application Publication
(10) Pub. No.: US 2009/0179816 A1
(43) Pub. Date: Jul. 16, 2009

(54) Antenna system for producing circular polarized waves with PIFAs

(76) Inventors: Yen-Ming Chen, Chiayi County (TW); Cheng-Chi Hu, Taipei City (TW)

Correspondence Address: NORTH AMERICA INTELLECTUAL PROPERTY CORPORATION, P.O. BOX 506, MERRIFIELD, VA, 22116, US

(21) Appl. No.: 12/116,966

(22) Filed: May 8, 2008

(30) Foreign Application Priority Data
Jan. 12, 2008 (CN) 200810025830.4

(51) Int. Cl. H01Q 1/50; H01Q 1/38

(52) U.S. Cl. 343/860; 343/700 MS

(57) ABSTRACT

Two PIFAs substantially perpendicular to each other have feed points facing each other and ends connected. A phase transformer is coupled to one of the PIFAs to produce a phase difference of 90 degrees in electric fields generated by these two PIFAs so as to generate circular polarized waves.

### BACKGROUND OF THE INVENTION

1. Field of the Invention

The present invention relates to an antenna system, especially to an antenna system for producing circular polarized waves with PIFAs.

2. Description of the Prior Art

With rapid advancement in technology in the modern era, information is increasing like a flood. Accordingly, transmission of the information requires highly developed communications technology. A communications system can be roughly categorized into 3 parts: data transmission, data receiving, and a medium. However, the medium used for data transmission and receiving differs for different applications. Taking prevailing wireless communications as an example, the medium used for data transmission in wireless communication is electromagnetic waves, and the device used for receiving and transmitting electromagnetic waves is an antenna. Hence the quality of an antenna influences the quality of data transmission and receiving drastically and directly, and it is important for a designer to choose an appropriate antenna when designing a wireless product. As portable wireless products are designed smaller and thinner in size, and lighter in weight, the size and weight of an antenna shrinks correspondingly. Antennas used recently in portable wireless products can be categorized as follows:

1. Printed microstrip antennas: Produced during fabrication of a PCB, may be integrated into a system mechanism, and also known as a “printed antenna”.

2. Micro-antennas: Examples include patch antennas, PIFAs (Planar Inverted F Antennas), and surface-mountable antennas, the most attractive being the PIFA, having a short circuit and capable of shrinking the size of the antenna by changing the resonant wavelength of the antenna from λ/2 to λ/4.

3. Chip antennas: Examples include multi-layer ceramic-base chips, and planar metal-plate chips, the multi-layer ceramic-base chip made of ceramic material having smaller size and being suitable for high frequency communication due to the high dielectric constant and the low dielectric loss of ceramic material.

Antennas may also be categorized into linear polarized antennas, circular polarized antennas, and elliptic polarized antennas, etc. according to wave types generated for data transmission and receiving. The linear polarized antennas, such as the PIFA, produce linear polarized electromagnetic waves as a medium for data transmission and receiving, the circular polarized antennas produce circular polarized electromagnetic waves as a medium, and the elliptic polarized antennas produce elliptic polarized electromagnetic waves as a medium. Generally speaking, if the signals used for data transmission and receiving are emitted from a base station on the ground, such as a GSM system, the linear polarized electromagnetic waves are often chosen as the medium for data transmission and receiving in such a system to decrease the transmission loss caused by obstacles lying in planar transmitting paths. However, if the communication system has a relay station on a satellite, such as a GPS system, circular polarized electromagnetic waves can be chosen as the medium for data transmission and receiving as the transmission paths between the relay station and the receiving device have very few obstacles. Please refer to FIG. 1, which illustrates electric fields radiated by a patch antenna producing circular polarized electromagnetic waves according to the prior art.

A linear polarized antenna is low cost, directional, and has a simple mechanism. On the other hand, when receiving data, the directional linear polarized antenna can only receive polarized electromagnetic waves transmitted in a certain direction; therefore it must be disposed according to the certain direction, responds slowly, and takes a long time to position. A circular polarized antenna is high cost, less directional, and has a complicated mechanism. When receiving data, the less directional circular polarized antenna can position quickly, has a shorter response time, produces fewer positioning errors, and can resist signal chaos caused by multipaths. Compared with the circular polarized antennas, the linear polarized antennas receive more noise when in an environment surrounded by tall buildings and full of multipath interference. These two kinds of antennas have their respective advantages and disadvantages, and how to keep the strengths of these two and reduce the weaknesses of both to produce a perfect antenna is an important topic in today's antenna design field.

### SUMMARY OF THE INVENTION

The present invention relates to an antenna system for utilizing PIFAs to generate circular polarized waves. The antenna system comprises a first PIFA, a second PIFA, a power divider, a phase transformer, and an impedance matching network. The first PIFA comprises a first feed point. The second PIFA comprises a second feed point, the second PIFA substantially perpendicular to the first PIFA, the feed points of these two PIFAs facing each other, and ends of these two PIFAs connected. The power divider coupled between the first feed point of the first FIFA and the second feed point of the second PIFA is for equally dividing power of electric fields fed into the first PIFA and the second PIFA. The phase transformer coupled between the second feed point of the second PIFA and the power divider is for producing a 90-degree phase difference in electric fields generated by the first PIFA and the second PIFA respectively. The impedance matching network coupled to the power divider is for calibrating central frequency offsets of the first PIFA and the second PIFA.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of electric fields radiated by a conventional patch antenna producing circular polarized electromagnetic waves.

FIG. 2 is a diagram of electric fields of dextrorotatory circular polarized electromagnetic waves.

FIG. 3 is a diagram illustrating locations of two PIFAs in a GPS antenna system according to an embodiment of the present invention.

FIG. 4 is a schematic diagram of the GPS antenna system in FIG. 3.

FIG. 5 is a block diagram of the GPS antenna system in FIG. 3.

FIG. 6 is a diagram illustrating how the central frequency of the antennas is shifted after a T-junction power divider is applied between the two PIFAs.

FIG. 7 is a block diagram in which a T impedance matching network is applied according to another embodiment of the present invention.

FIG. 8 is a block diagram in which a bridged-T impedance matching network is applied according to a further embodiment of the present invention.

FIG. 9 is a distribution diagram of electric fields of the GPS antenna system of FIG. 3.

FIG. 10 is a simulation diagram of electric fields of the GPS antenna system of FIG. 3.

FIG. 11 is a distribution diagram of electric fields emitted from the GPS antenna system in FIG. 3 measured in a vertical XY plane in an antenna chamber laboratory under conditions of two PIFAs being placed in an XY plane with a phase difference of 90 degrees in electric fields generated by these two PIFAs.

FIG. 12 is a block diagram of the antenna system emitting levorotary circular polarized electromagnetic waves according to another embodiment of the present invention.

### DETAILED DESCRIPTION

The antenna system of the present invention utilizes two substantially perpendicular PIFAs with feed points facing each other and ends connected. An inductor is coupled to one of these two PIFAs to produce a phase difference of 90 degrees in electric fields generated by the antennas so as to generate circular polarized waves.

There are 2 limitations of generating a circular polarized wave: 1) the directions of two electric fields Ex and Ey are orthogonal, and 2) the vectors of these two electric fields are of the same magnitude, but have a phase difference of 90 degrees. Moreover, if the electromagnetic waves intended to be produced are dextrorotatory, then a third limitation should be added as: 3) the horizontal electric field Ex should lead the vertical electric field Ey by π/2, namely the proceeding direction of the circular polarized electromagnetic waves is along a +Z axis. Contrarily, if the electromagnetic waves intended to be produced are levorotatory, then the limitation should be changed as: 3) the horizontal electric field Ex should lag the vertical electric field Ey by π/2, namely the proceeding direction of the circular polarized electromagnetic waves is along the +Z axis. Taking a dextrorotatory circular polarized electromagnetic wave as an example, its electric field may be expressed by the following equations:

Ex0=Ey0=E0

φ=φx−φy=π/2

Wherein Ex0 and Ey0 are the magnitudes of the electric fields Ex and Ey, respectively, and φx, φy are the phases of the electric fields Ex and Ey, respectively.

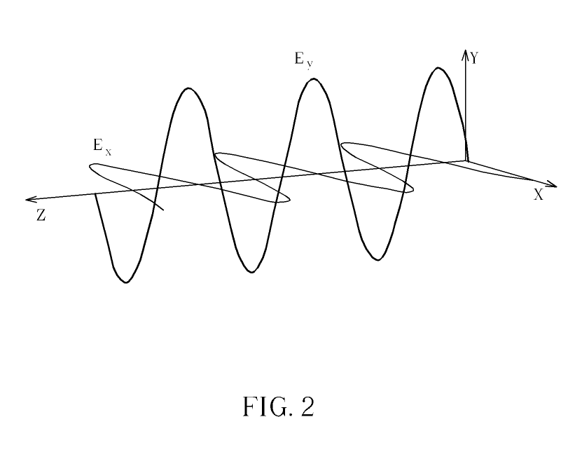

Please refer to FIG. 2. FIG. 2 is a diagram of the electric fields of the dextrorotatory circular polarized electromagnetic waves according to the present invention. Because the exemplary embodiment given here is a GPS antenna system, the rotary direction of the electric fields illustrated in FIG. 2 is dextrorotatory. In other words, in circuitry illustrated in FIG. 2, an inductor may be disposed between a second feeding point of a second PIFA and a T-junction power divider so as to generate the dextrorotatory circular polarized electromagnetic waves. It should be noted that the dextrorotatory circular polarized electromagnetic waves shown in FIG. 2 and applied in the antenna system of the embodiment are for illustrative purposes only, and are not meant to be limitations of the present invention. The levorotary circular polarized electromagnetic waves can be applied in the antenna system of the present invention as well, such as in a military communications system. That is, an inductor may be disposed between a first feeding point of a first PIFA and a T-junction power divider in the circuitry so as to generate the levorotary circular polarized electromagnetic waves.

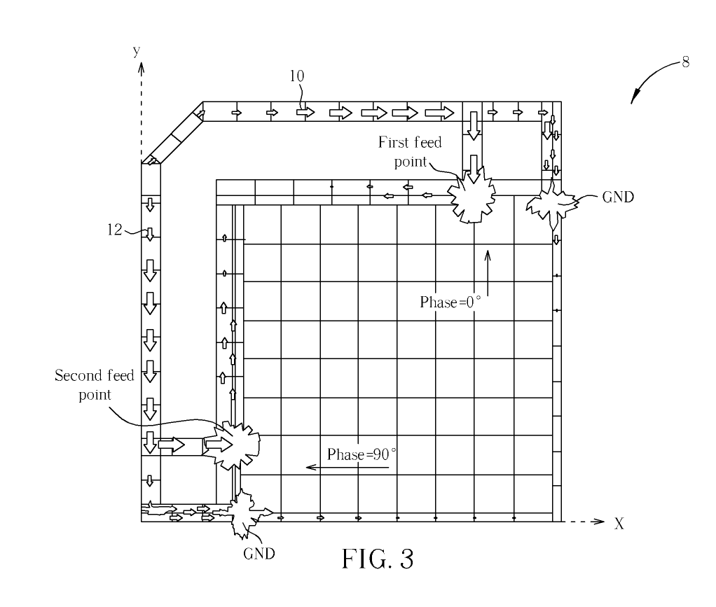

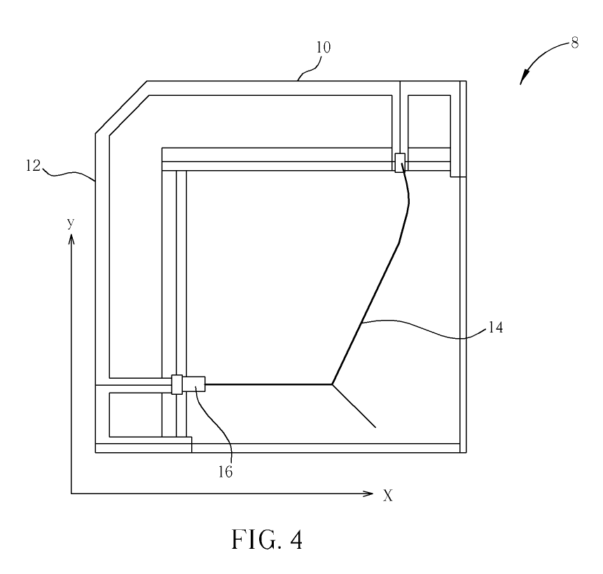

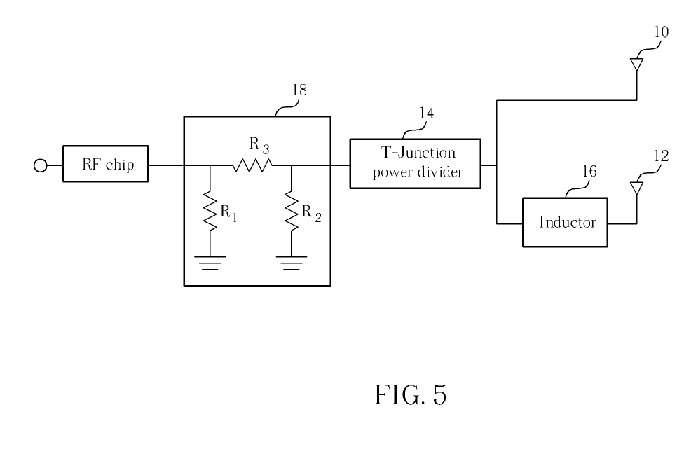

Please refer to FIG. 3, FIG. 4, and FIG. 5 together. FIG. 3 is a diagram illustrating locations of the two PIFAs in a GPS antenna system 8 according to the embodiment of the present invention. FIG. 4 is a schematic diagram of the GPS antenna system 8. FIG. 5 is a block diagram of the GPS antenna system 8. GPS antenna system 8 includes a first PIFA 10 with a center frequency of 1.575 GHz, a second PIFA 12 with a center frequency of 1.575 GHz, a T-junction power divider 14, an inductor 16, and a π impedance matching network 18. The first PIFA 10 includes a first feed point, and the second PIFA 12 includes a second feed point and is substantially perpendicular to the first PIFA 10. The first feed point of the first PIFA 10 and the second feed point of the second PIFA 12 face each other, and moreover, the ends of these two PIFAs are coupled together. It should be noted that the second PIFA 12 is substantially perpendicular to the first PIFA 10 in theory, but in application, if these two PIFAs are not perfectly perpendicular to each other, and perpendicular angle errors are within several degrees, the produced polarized electromagnetic waves will no longer be circular but may be slightly elliptic, but may still be usable in such a situation according to this embodiment.

The T-junction power divider 14 coupled between the first feed point of the first PIFA 10 and the second feed point of the second PIFA 12 is for equally dividing power of the electric fields fed into the first PIFA and the second PIFA. The word “couple” used here indicates the T-junction power divider 14 is directly or indirectly connected to the first feed point of the first PIFA 10 and the second feed point of the second PIFA 12. In FIG. 3, a current flows from the end of the first PIFA 10 to the first feed point and ground, and another current flows from the end of the second PIFA 12 to the second feed point and ground. Moreover, the inductor 16 coupled between the second PIFA 12 and the T-junction power divider 14 produces a phase lag of 90 degrees in the electric fields from the second PIFA 12 to the first PIFA 10. The π impedance matching network 18 coupled to the T-junction power divider 14 may be used for calibrating center frequency offsets of both the first PIFA and the second PIFA.

The T-junction power divider 14 used for equally dividing power of the electric fields fed into the first PIFA 10 and the second PIFA 12 is for illustrative purposes only, and is not meant to be a limitation of the present invention. Other kinds of power dividers may be capable of achieving the same result, are well known to those skilled in the art, and may be applied in the present invention as well. Please note that the inductor 16 may be replaced by a microstrip line, which can induce equivalent inductance corresponding to the inductor 16 according to another embodiment of the present invention. In a GPS system, the wavelength of the electromagnetic waves used for data transmission and receiving is around 4.7 cm; therefore the length of the microstrip line should equal half the wavelength of the electromagnetic waves, or about 2.35 cm, in order to induce equivalent inductance. It should be noted that the above mentioned inductor 16 and microstrip line are for illustrative purposes only, and are not meant to be limitations of the present invention. Other kinds of phase transformers capable of offering the same result and well known to those skilled in the art may be applied in the present invention as well.

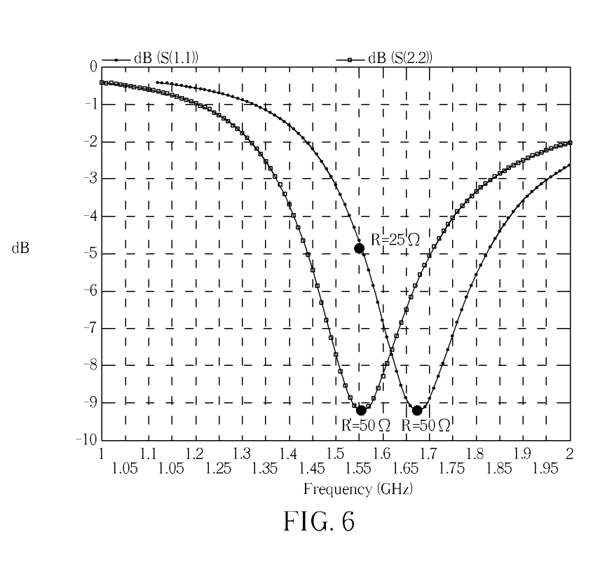

When the T-junction power divider 14 is applied between the first PIFA 10 and the second PIFA 12, because these two PIFAs are similar and in a parallel connection, after being joined together, the equivalent resistance may become half the original resistance of these two PIFAs. For example, if the resistance of each antenna is 50Ω, the resistance after joining together may be 25Ω. But, the input resistance of an RF chip down the line may still require 50Ω; therefore the center frequency of these two antennas may shift due to a resistance mismatch. Hence, the π impedance matching network 18 is applied to adjust the center frequency of the antennas back to the original center frequency of 1.575 GHz. Please refer to FIG. 6. FIG. 6 is a diagram illustrating how the center frequency of the antennas is shifted after the T-junction power divider 14 is applied between these two PIFAs.

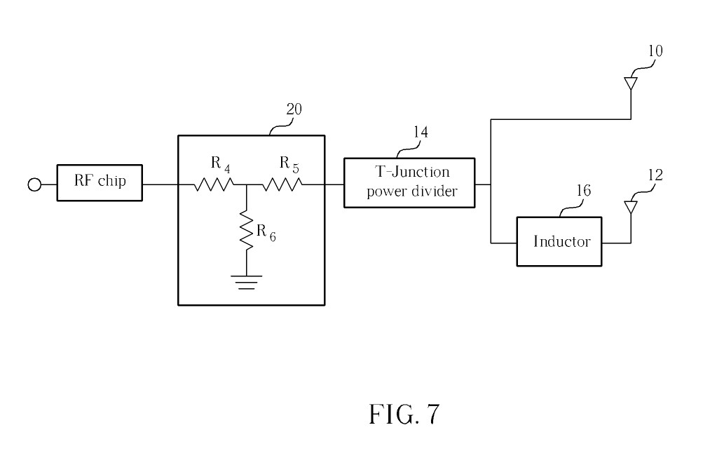

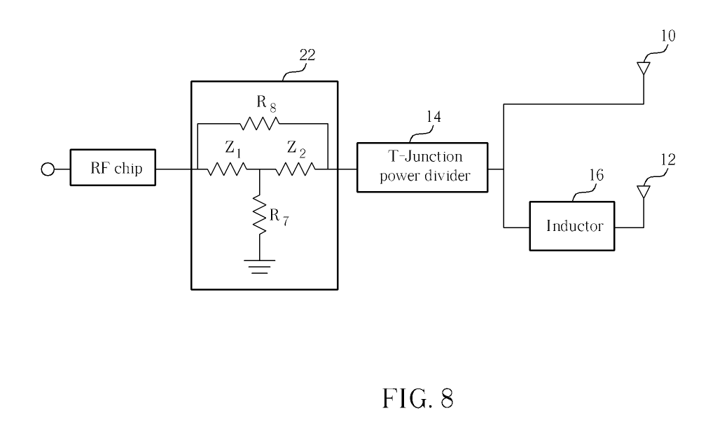

The π impedance matching network 18 includes two equivalent resistors R1, R2 connected in parallel and a serially connected equivalent resistor R3. Please refer to FIG. 5. FIG. 5 is a block diagram in which the π impedance matching network 18 is applied to the GPS antenna system 8. The π impedance matching network 18 used for calibrating the center frequency offsets of the first PIFA 10 and the second PIFA 12 is for illustrative purposes only, and is not meant to be a limitation of the present invention. Other kinds of impedance matching networks capable of performing the same result and well known to those skilled in the art may be applied in the present invention as well. Please refer to FIG. 7. FIG. 7 is the block diagram in which a T impedance matching network 20 is applied in the GPS antenna system 8 according to another embodiment of the present invention. In FIG. 7, the T impedance matching network 20 includes two serially connected equivalent resistors R4 and R5, and an equivalent resistor R6 connected in parallel. Please refer to FIG. 8. FIG. 8 is the block diagram in which a bridged-T impedance matching network 22 is applied in the GPS antenna system 8 according to a further embodiment of the present invention. In FIG. 8, the bridged-T impedance matching network 22 includes serially connected equivalent impedances Z1 and Z2, an equivalent resistor R7 connected in parallel, and a bridged equivalent resistor R8.

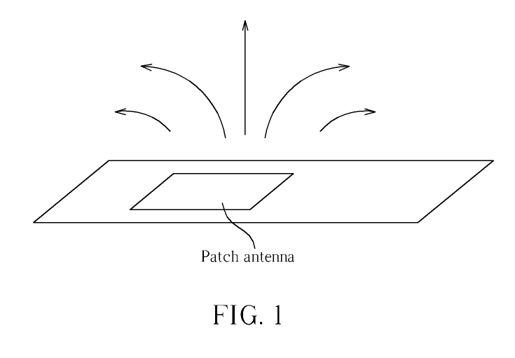

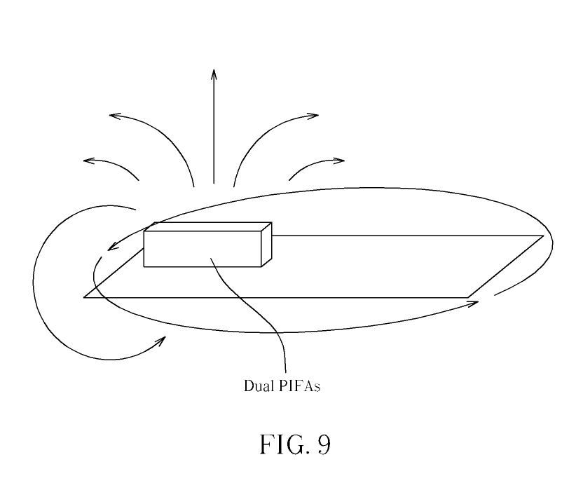

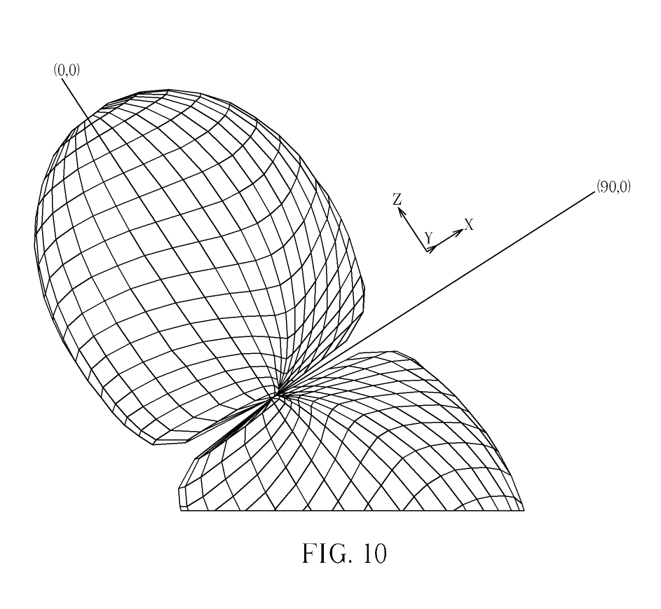

Please refer to FIG. 9. FIG. 9 is a distribution diagram of electric fields of the GPS antenna system 8 according to the embodiment of the present invention. Comparing electric fields of the patch antenna illustrated in FIG. 1 with electric fields of the GPS antenna system 8 illustrated in FIG. 9, radiant energy of the patch antenna is mainly concentrated on an upper side of the radiant surface; however the radiant fields of the GPS antenna system 8 are in all directions. Therefore, the radiant surface of the patch antenna should be disposed toward an upper side of a product, but this design limitation may increase thickness of the product dramatically, and may also add difficulties to design. Please refer to FIG. 9 and FIG. 10 together. FIG. 10 is a simulation diagram of electric fields of the GPS antenna system 8 according to the present invention. From FIG. 9 and FIG. 10, shape of radiant electric fields of the GPS antenna system 8 can be seen to approach a sphere; therefore the dual PIFAs do not have to be designed on the upper side of the product like other linear polarized antennas do, which typically need to be placed on the windshield of an automobile as a rule. Hence, the antenna system of the present invention neither increases the thickness of the product nor difficulty of design of the product.

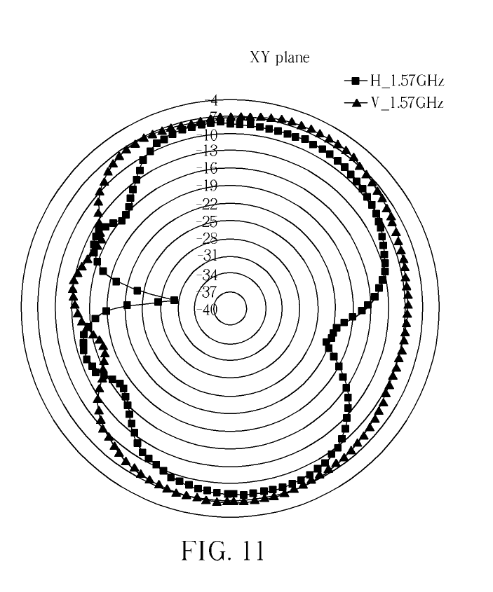

Please refer to FIG. 11. FIG. 11 is a distribution diagram of electric fields emitted from the GPS antenna system 8 measured in a vertical XY plane (E-theta plane) in an antenna chamber laboratory under conditions of two PIFAs being placed in an XY plane with a phase difference of 90 degrees in electric fields generated by these two PIFAs (that is, one PIFA emits horizontal electric fields Ex, and the other PIFA emits vertical electric fields Ey) according to the embodiment of the present invention. In FIG. 10, a curve formed by square points represents the horizontal electric fields Ex emitted by one of these two PIFAs emitting horizontal linear polarized electromagnetic waves, and a curve formed by triangular points represents the vertical electric fields Ey emitted by the other PIFA emitting vertical linear polarized electromagnetic waves. From FIG. 11, we can see the electric fields Ex and Ey approximately overlap, that is Ex and Ey are approximately the same, from 0-90 and 150-180 degrees, meaning that the circular polarized waves resonated by Ex and Ey are well-formed in these angle ranges. According to the embodiment of the present invention, the main application range of the circular polarized waves generated in the GPS antenna system 8 may be from −60 to +60 degrees.

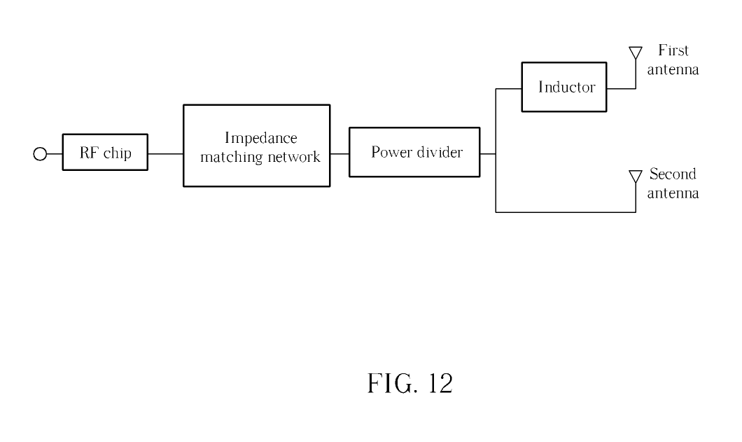

Please refer to FIG. 12. FIG. 12 is a block diagram of the antenna system emitting levorotary circular polarized electromagnetic waves according to another embodiment of the present invention. Theorems and functions of the levorotary antenna system are similar to the antenna system emitting dextrorotatory circular polarized electromagnetic waves; therefore the detailed description is omitted here for brevity.

The present invention utilizes two linear polarized PIFAs to produce circular polarized electric fields by changing how electric fields are fed into these two PIFAs, and is capable of keeping advantages of both the circular polarized waves and the linear polarized waves at the same time. Moreover, printing PIFAs on a PCB may reduce the thickness of the product, and the design and the disposed location of the product are more flexible compared with a linear polarized antenna system. In addition, according to the embodiment of the present invention, an inductor is used in the antenna system to shrink the size of the product and produce a phase difference of 90 degrees between the two PIFAs. To sum up, the present invention combines the advantages of the linear polarized antennas and the circular polarized antennas, including low cost, easy production, and easy design, but is also resistant to the signal chaos caused by multipaths, and has fast positioning.

Those skilled in the art will readily observe that numerous modifications and alterations of the device and method may be made while retaining the teachings of the invention.

What is claimed is:

1. An antenna system for utilizing Planar Inverted F Antennas (PIFAs) to generate circular polarized waves, the antenna system comprising:
a first PIFA comprising a first feed point;
a second PIFA comprising a second feed point, the second PIFA substantially perpendicular to the first PIFA, the feed points of these two PIFAs facing each other, and ends of these two PIFAs connected;
a power divider coupled between the first feed point of the first FIFA and the second feed point of the second PIFA for equally dividing power of electric fields fed into the first PIFA and the second PIFA;
a phase transformer coupled between the second feed point of the second PIFA and the power divider for producing a 90-degree phase difference in electric fields generated by the first PIFA and the second PIFA respectively; and
an impedance matching network coupled to the power divider for calibrating central frequency offsets of the first PIFA and the second PIFA.

2. The antenna system of claim 1, wherein the phase transformer is an inductor for producing a phase lag of 90 degrees in electric fields from the second PIFA to the first PIFA.

3. The antenna system of claim 1, wherein the phase transformer is a microstrip line whose length is half a wavelength of resonance generated by the first PIFA and the second PIFA.

4. The antenna system of claim 1, wherein the power divider is a T-junction power divider.

5. The antenna system of claim 1, wherein the impedance matching network is a π impedance matching network.

6. The antenna system of claim 1 wherein the impedance matching network is a T impedance matching network.

7. The antenna system of claim 1 wherein the impedance matching network is a bridged-T impedance matching network.

8. The antenna system of claim 1 wherein the first PIFA is disposed in a horizontal direction, the end of the first PIFA is on the left side of the first PIFA, the second PIFA is disposed in a vertical direction, and the end of the second PIFA is on the upper side of the second PIFA.

9. The antenna system of claim 1 wherein the second PIFA is disposed in a horizontal direction, the end of the second PIFA is on the left side of the second PIFA, the first PIFA is disposed in a vertical direction, and the end of the first PIFA is on the upper side of the first PIFA.
